(19) United States
(12) Patent Application Publication
(10) Pub. No.: US 2009/0306998 A1
(43) Pub. Date: Dec. 10, 2009

(54) DESKTOP ACCESS FROM WITHIN A VIRTUAL UNIVERSE

(76) Inventors: Rick A. Hamilton, II, Charlottesville, VA (US); Brian M. O'Connell, Cary, NC (US); Clifford A. Pickover, Yorktown Heights, NY (US); Keith R. Walker, Austin, TX (US)

Correspondence Address: HOFFMAN WARNICK LLC, 75 STATE ST, 14TH FLOOR, ALBANY, NY, 12207, US

(21) Appl. No.: 12/134,850

(22) Filed: Jun. 6, 2008

(51) Int. Cl. G06F 3/048; G06Q 30/00

(52) U.S. Cl. 705/1; 715/740

(57) ABSTRACT

An approach that provides desktop access from within a virtual universe is described. In one embodiment, there is a desktop invocation component configured to invoke a client computer desktop from within a virtual universe in response to receiving a request to access the client computer desktop from within the virtual universe. A rendering component is configured to generate a rendition of the client computer desktop in the virtual universe in response to the invoking thereof. An interaction component is configured to permit interaction with the client computer desktop from the rendition in the virtual universe.

### CROSS REFERENCE TO RELATED APPLICATIONS

This patent application relates to commonly-assigned U.S. patent application Ser. No. 12/120,791 (IBM Docket Number END920070133US1), entitled “VIRTUAL UNIVERSE DESKTOP EXPLORATION FOR RESOURCE ACQUISITION” filed on May 15, 2008, and U.S. patent application Ser. No. 12/131,581 (IBM Docket Number END920070134US1), entitled “RESOURCE ACQUISITION AND MANIPULATION FROM WITHIN A VIRTUAL UNIVERSE” filed on Jun. 2, 2008.

### FIELD OF THE INVENTION

This invention relates generally to virtual environments and more specifically to providing access to a client computer desktop from within a virtual universe.

### BACKGROUND OF THE INVENTION

Virtual universes or virtual worlds are computer-based simulated environments intended for its users to inhabit and interact via avatars, which are personas or representations of the users of the virtual universes and generally take the form of two-dimensional or three-dimensional human or fantastical representations of a person's self. These types of virtual universes are now most common in massively multiplayer online games such as Second Life which is a trademark of Linden Research in the United States, other countries or both. Avatars in these types of virtual universes, which can number well over a million, have a wide range of business and social experiences.

Because there are a wide range of business and social experiences associated with these virtual universes, users can spend a great deal of time in these universes. Often users are reluctant to leave these virtual universes to obtain items that could be useful for enhancing their business and social experiences within the universes. For example, while inside of a virtual universe, a user often has a need to access resources outside of the universe that include files, images, business documents, etc. Presently, users of virtual universe client software are unable to acquire, manipulate, or mutate the external resources of the local computer from within the virtual universe client. The users have to leave the virtual universe to access the local computer which typically will affect their overall experience.

### SUMMARY OF THE INVENTION

In one embodiment, there is a method for accessing a client computer desktop from within a virtual universe. In this embodiment, the method comprises: receiving a request to access the client computer desktop from within the virtual universe; invoking the client computer desktop in response to receiving the request; generating a rendition of the client computer desktop in the virtual universe in response to the invoking thereof, and permitting interaction with the client computer desktop from the rendition in the virtual universe.

In a second embodiment, there is a computer system for permitting access to a client computer desktop from within a virtual universe. In this embodiment, the system comprises at least one processing unit and memory operably associated with the at least one processing unit. A desktop access tool is storable in memory and executable by the at least one processing unit, the tool. The desktop access tool comprises a desktop invocation component configured to invoke the client computer desktop from within the virtual universe in response to receiving a request to access the client computer desktop from within the virtual universe. A rendering component is configured to generate a rendition of the client computer desktop in the virtual universe in response to the invoking thereof. An interaction component is configured to permit interaction with the client computer desktop from the rendition in the virtual universe.

In a third embodiment, there is a computer-readable medium storing computer instructions, which when executed, enables a computer system to access a client computer desktop from within a virtual universe. In this embodiment, the computer instructions comprise: invoking the client computer desktop from within the virtual universe in response to receiving a request to access the client computer desktop from within the virtual universe; generating a rendition of the client computer desktop in the virtual universe in response to the invoking thereof, and permitting interaction with the client computer desktop from the rendition in the virtual universe.

In a fourth embodiment, there is a method for deploying a desktop access tool for use in a computer system that accesses a client computer desktop from within a virtual universe. In this embodiment, a computer infrastructure is provided and is operable to: receive a request to access the client computer desktop from within the virtual universe; invoke the client computer desktop in response to receiving the request; generate a rendition of the client computer desktop in the virtual universe in response to the invoking thereof, and permit interaction with the client computer desktop from the rendition in the virtual universe.

### BRIEF DESCRIPTION OF THE DRAWINGS

FIG. 1 shows a high-level schematic diagram showing a networking environment for providing a virtual universe according to one embodiment of this invention;

FIG. 2 shows a more detailed view of the virtual universe client shown in FIG. 1;

FIG. 3 shows a more detailed view of some of the functionalities provided by the server array shown in FIG. 1;

FIG. 4 shows a desktop access tool according to one embodiment of this invention that operates in the environment shown in FIG. 1; and

FIG. 5 shows a schematic of an exemplary computing environment in which elements of the networking environment shown in FIG. 1 may operate.

### DETAILED DESCRIPTION OF THE INVENTION

Embodiments of this invention are directed to a technique for enabling users of a virtual universe to interact with a client computer desktop and applications through an interface within the virtual universe. In particular embodiments, a client computer's desktop is rendered within the virtual universe and the user and/or its avatar is able to invoke applications and manage resources through the rendering of the computer desktop.

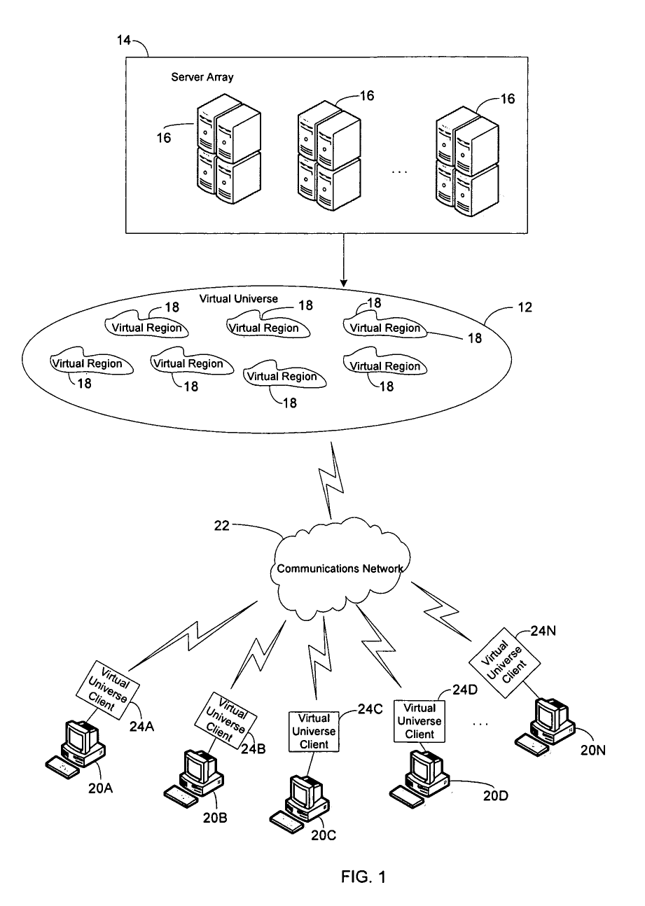

FIG. 1 shows a high-level schematic diagram showing a networking environment 10 for providing a virtual universe 12 according to one embodiment of this invention in which a client computer desktop access tool can be utilized. As shown in FIG. 1, the networking environment 10 comprises a server array or grid 14 comprising a plurality of servers 16 each responsible for managing a sliver of virtual real estate within the virtual universe 12. A virtual universe provided by a typical massively multiplayer online game can employ thousands of servers to manage all of the virtual real estate. The content of the virtual real estate that is managed by each of the servers 16 within the server array 14 shows up in the virtual universe 12 as a virtual region 18. Like the real-world, each virtual region 18 within the virtual universe 12 comprises a living landscape having things such as buildings, stores, clubs, sporting arenas, parks, beaches, cities and towns all created by residents of the universe that are represented by avatars. These examples of items are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe, or even only one region in a small virtual universe. FIG. 1 also shows that users operating computers 20A-20N (hereinafter referred generally as 20) interact with the virtual universe 12 through a communication network 22 via virtual universe clients 24A-24N (hereinafter referred generally as 24) that resides in the computers, respectively. Below are further details of the virtual universe 12, server array 14, and virtual universe client 24.

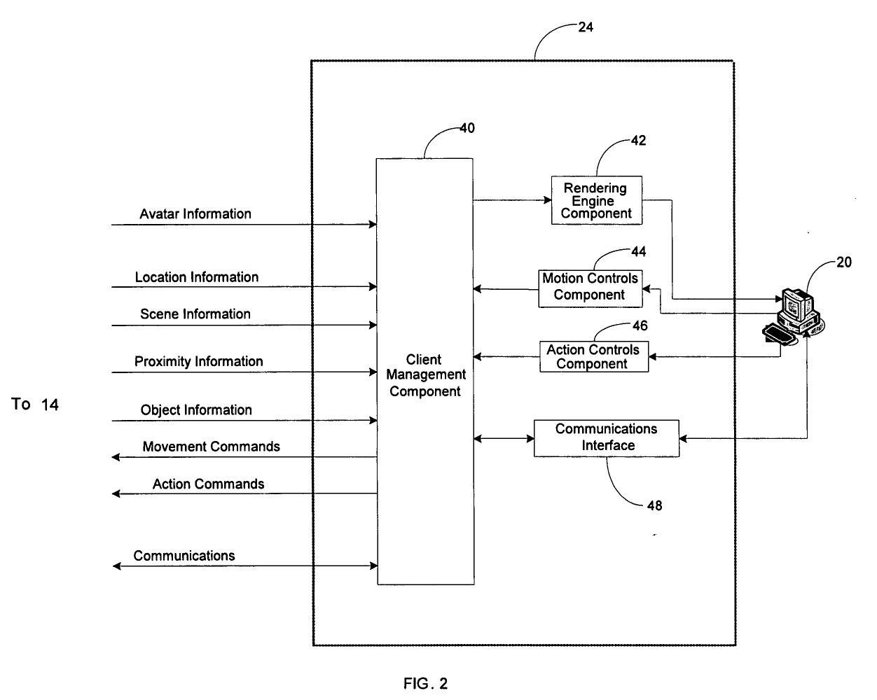

FIG. 2 shows a more detailed view of the virtual universe client 24 shown in FIG. 1. The virtual universe client 24, which enables users to interact with the virtual universe 12, comprises a client management component 40, which manages actions, movements and communications made by a user through computer 20, and information received from the virtual universe through the server array 14. A rendering engine component 42 enables the user of the computer 20 to visualize his or her avatar within the surroundings of the particular region of the virtual universe 12 that it is presently located. A motion controls component 44 enables the user to make movements through the virtual universe. In one embodiment, movements through the virtual universe can include for example, gestures, postures, walking, running, driving, flying, etc. An action controls component 46 enables the user to perform actions in the virtual universe such as buying items for his or her avatar or even for their real-life selves, building homes, planting gardens, etc. These actions are only illustrative of some possible actions that a user can perform in the virtual universe and are not limiting of the many possible actions that can be performed. A communications interface 48 enables a user to communicate with other users of the virtual universe 12 through modalities such as chatting, instant messaging, gesturing, talking and electronic mail (e-mail).

FIG. 2 shows the various types of information received by the client management component 40 from the virtual universe through the server array 14. In particular, the client management component 40 receives avatar information about the avatars that are in proximity to the user's avatar. In addition, the client management component 40 receives location information about the area that the user's avatar is near (e.g., what region or land he or she is in) as well as scene information (e.g., what the avatar sees). The client management component 40 also receives proximity information which contains information on what the user's avatar is near and object information which is information that can be obtained by one's senses (e.g., touch, taste, smell, etc.,) and what actions are possible for nearby objects (e.g., invoking, pushing, picking up, etc.). FIG. 2 also shows the movement commands and action commands that are generated by the user are sent to the server array via the client management component 40, as well as the communications that can be sent to the users of other avatars within the virtual universe.

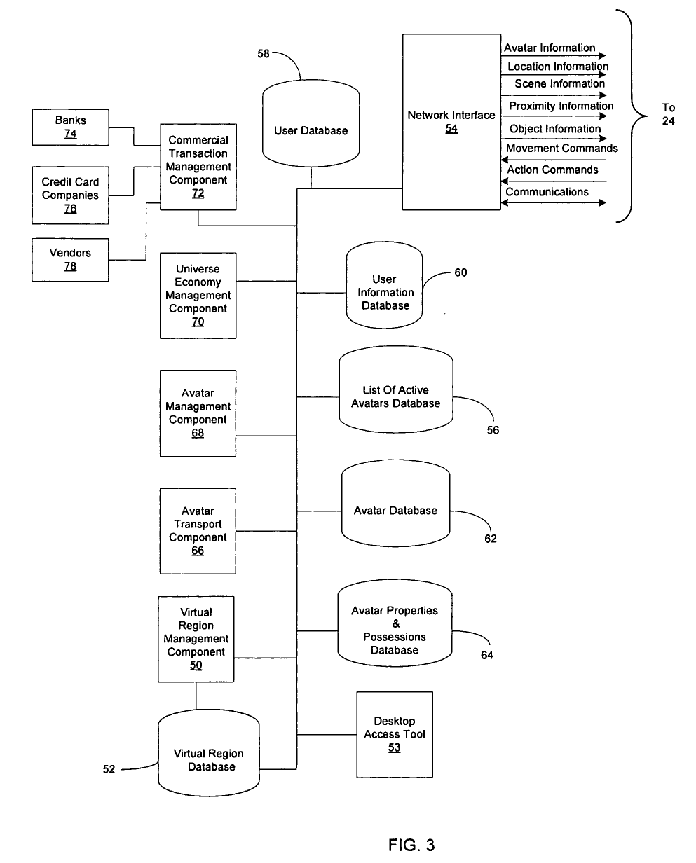

FIG. 3 shows a more detailed view of some of the functionalities provided by the server array 14 shown in FIG. 1. In particular, FIG. 3 shows a virtual region management component 50 that manages a virtual region within the virtual universe. In particular, the virtual region management component 50 manages what happens in a particular region such as the type of landscape in that region, the number of homes, commercial zones, boutiques, streets, parks, restaurants, etc. For example, the virtual region management component 50 would allow the owner of a particular region or establishment within the region to specify requirements for entering or remaining within the region that could potentially affect certain avatar characteristics. In addition, the virtual region management component 50 would allow the owner of a particular region or establishment to provide a textual description that describes the area in more detail so that the avatars can ascertain if there will be a potential effect on their use of specific inventory items within that region. Those skilled in the art will recognize that the virtual region management component 50 can manage many other facets within the virtual region.

A virtual region database 52 stores information on all of the specifics in the virtual region 18 that the virtual region management component 50 is managing. In one embodiment, for very large virtual universes, one server 16 may be responsible for managing one particular virtual region 18 within the universe. In other embodiments, it is possible that one server 16 may be responsible for handling one particular land within the virtual region 18.

A desktop access tool 53 provides the capability for users of the virtual universe and/or their avatars to access a client computer desktop. In particular, the desktop access tool 53 is configured to enable users of a virtual universe to interact with a client computer desktop and applications through an interface within the virtual universe. With the desktop access tool, a client computer's desktop is rendered within the virtual universe and the user and or its avatar is able to invoke applications and manage resources through the rendering of the computer desktop. Below is a more detailed discussion of the desktop access tool 53 and how it performs the above-mentioned functions.

FIG. 3 shows a network interface 54 that enables the server array 14 to interact with the virtual universe client 24 residing on computer 20. In particular, the network interface 54 communicates avatar, location, scene, proximity and object information to the user through the virtual universe client 24 and receives movement and action commands as well as communications from the user via the universe client.

As shown in FIG. 3, there are several different databases for storing information. In particular, database 56 contains a list of all the avatars that are online in the virtual universe 12. Databases 58 and 60 contain information on the actual human users of the virtual universe 12. In one embodiment, database 58 contains general information on the users such as names, addresses, interests, ages, etc., while database 60 contains more private information on the users such as email addresses, billing information (e.g., credit card information) for taking part in transactions. Databases 62 and 64 contain information on the avatars of the users that reside in the virtual universe 12. In one embodiment, database 62 contains information such as all of the avatars that a user may have, the profile of each avatar, avatar characteristics (e.g., appearance, voice and movement features) while database 64 contains an inventory listing properties and possessions that each avatar owns such as hair pieces, weapons, jewelry, houses, cars, sporting equipment, appearance, attire, etc. As virtual universes become more mainstream within a business setting, it is conceivable that users will want to have public and private inventories for their avatar in order to protect unwanted invention of confidential and proprietary information. Therefore, in one embodiment, the database 62 may contain public and private inventories in order to account for various business and social encounters that need to be shielded from unauthorized parties. Those skilled in the art will recognize that databases 58-64 may contain additional information if desired. Although the above information is shown in FIG. 3 as being stored in databases, those skilled in the art will recognize that other means of storing information can be utilized.

An avatar transport component 66 enables users to transport, which as mentioned above, allows avatars to transport through space from one point to another point, instantaneously. As a result, an avatar could for example travel from a business region to an entertainment region to hear a concert. Moving from one point or virtual region to another point could ultimately affect the inventory items that an avatar could use in a particular location. For example, if the avatar was leaving work from the business district with some proprietary information then the transformation tool of this invention could transform the proprietary information to a newspaper. In this example, well-known encryption/decryption techniques can be used in the transformation of documentation.

An avatar management component 68 keeps track of what online avatars are doing while in the virtual universe. For example, the avatar management component 68 can track where the avatar presently is in the virtual universe, what activities it is performing or has recently performed. An illustrative but non-exhaustive list of activities can include shopping, eating, talking, recreating, etc.

Because a typical virtual universe has a vibrant economy, the server array 14 has functionalities that are configured to manage the economy. In particular, a universe economy management component 70 manages transactions that occur within the virtual universe between avatars. In one embodiment, the virtual universe 12 will have their own currency that users pay for with real-life money. The users can then take part in commercial transactions for their avatars through the universe economy management component 70. For example, an avatar might want to pay for a service that provides this automatic inventory item transformation. In this case, the avatar would make the purchase of this service using the virtual universe currency. In some instances, the user may want to take part in a commercial transaction that benefits him or her and not their avatar. In this case, a commercial transaction management component 72 allows the user to participate in the transaction. For example, while walking around a commercial zone, an avatar may see a pair of shoes that he or she would like for themselves and not their avatar. In order to fulfill this type of transaction and others similarly related, the commercial transaction management component 72 interacts with banks 74, credit card companies 76 and vendors 78.

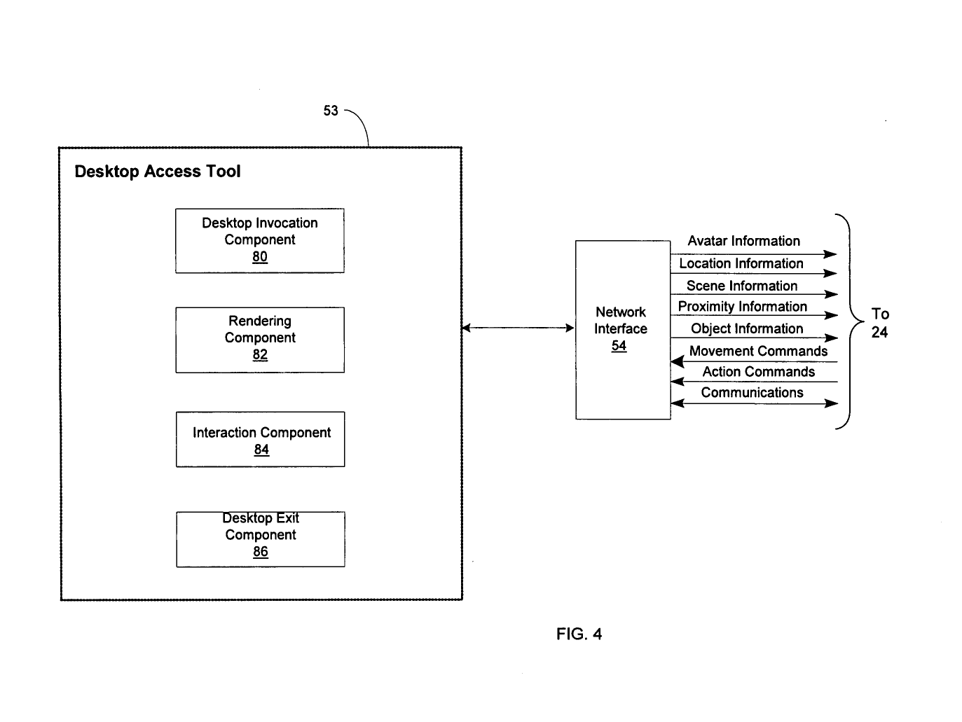

FIG. 4 shows a more detailed view of the desktop access tool 53. As mentioned above, the desktop access tool 53 provides the capability for users of the virtual universe and/or their avatars to access a client computer desktop. As a result, users and/or their avatars can interact with the client computer's desktop and applications through the virtual universe client 24. In particular, the client computer's desktop is rendered within the virtual universe 12 and the user is able to control, invoke applications and manage resources through the rendering of the computer's desktop.

As shown in FIG. 4, in this embodiment, the desktop access tool 53 resides on the same computer system as the server 14 and communicates directly to the virtual universe and its residents via the virtual universe client 24. In other embodiments, the desktop access tool 53 might reside on the same computers as the virtual universe client 24, or reside on separate computers in direct communication with the virtual universe servers 16 and virtual universe clients 24.

FIG. 4 shows that the desktop access tool 53 comprises a desktop invocation component 80 configured to invoke the client computer desktop 20 from within the virtual universe 12 in response to receiving a request to access the client computer desktop from within the virtual universe. The request can come from users of the virtual universe 12 or the avatars of these users. In addition, the request can take on many forms. A non-exhaustive list of examples includes selecting an action from a menu that indicates a desire to access a client computer desktop, selecting an item from the avatar's inventory that is representative of the client computer desktop, initiating an action by selecting an object rendered within the virtual universe 12 that is representative of the client computer desktop. In a preferred embodiment, the avatar can approach a rendering of a computer (e.g., a laptop if the computer is a laptop, or a desktop if the computer is a desktop) and perform a motion to indicate that the avatar would like access to the desktop. Possible examples of a motion include pressing an “on button” for the computational device which could for example include a personal computer, handheld device, kiosk, television, phone or video game.

A rendering component 82 is configured to render the client computer desktop 20 in the virtual universe 12 in response to the desktop invocation component 80 invoking the desktop. In one embodiment, the rendering component 82 provides a continuous display of a current state of the client computer desktop. Those skilled in the art will recognize that are many options available to render the display of the client computer desktop. In one embodiment, the rendering will be located within a frame. In another embodiment, an image will be rendered around the desktop that replicates the surrounding material of a computer monitor. In another embodiment, the rendering component 82 may opt to render a view over the avatar's shoulder and the user's actions on the client computer can be transmitted through the avatar onto a simulacrum of the computer (e.g., such as hands on keyboard pressing keys, hands leaving keyboard to move mouse, etc.) and then transmitted to the client computer desktop. The rendering may be a pixel per pixel copy, or a scale of the desktop's pixels in order to fit within the allocated dimensions in the virtual universe 12. The rendering may be stretched and skewed to mimic viewing the desktop from angles other than directly in front of the desktop. It should be apparent that other rendering techniques such as enabling zoom and pan features may be applied. In cases where a desktop spans multiple physical displays, they may be rendered similarly, such as one rendering area per display, or merged into a single rendering area, or rendered one at a time, where the display to be rendered may be toggled, such as with tabbed pages where each page represents a separate physical display.

Until virtual universe grids and networks become more capable of streaming, the transmission of data can be done between the virtual universe client 24 and the remote client directly, without the virtual universe grid acting as a proxy. When the virtual universe client 24 and the desktop run on the same device, the rendering may be performed directly by the virtual universe client 24 rather than the server 14. In such cases, the ability to view or access the virtual universe client 24 within the rendered desktop may be suppressed to prevent a rendering loop. However, when virtual universe grids and networks become more capable, they may act as a proxy, which will allow further embodiments such as: (1) the ability to record and store the session in a virtual universe grid database and (2) the ability for others in the virtual universe to see or interact with the remote client at the same time (assuming it is shared).

FIG. 4 shows that the desktop access tool 53 further comprises an interaction component 84 configured to permit interaction with the client computer desktop from the rendering in the virtual universe. In one embodiment, the interaction component permits the user and/or avatar to invoke application software including, but not limited to word processors, graphics editors, email clients. Once invoked the user and/or avatar has full access to the features of these applications. In one embodiment, the interaction component permits the user and/or avatar to invoke system software such as for example the operating system. The users and/or avatars may control the operating system's desktop by using known methods for controlling computers such as pointing devices or a keyboard. In response to keystrokes or the movement of pointer devices the virtual universe client 24 transmits these input commands from the client to the desktop access tool 53.

In another embodiment, the interaction component 84 is configured to permit users and/or avatars to manage resources of the client computer desktop. A non-exhaustive list of resources that can be managed include documents, programs, storage devices, media files, and hardware devices.

The interaction component 84 is configured to permit other actions in addition to those actions mentioned above. For example, if text is copied from an application into an operating system's short-term anonymous data store (clipboard and other operating systems), then that text is available to the user within the virtual universe's short-term anonymous and private data store. In another example, if a graphic is loaded in a graphical editing program within the desktop and the graphic is copied to the operating system's short-term anonymous and private data store, then the graphical image is copied to the virtual universe's short-term anonymous and private data store. In another embodiment, the image may be converted to a format native to the virtual universe.

It should be appreciated that the above actions are only exemplary and are not intended to assert or imply any limitation with regard to the environments in which different embodiments may be implemented. Many modifications to the type, scope, or invocation of acceptable actions are within the scope of this invention.

As shown in FIG. 4, the desktop access tool 53 further comprises a desktop exit component 86 configured to terminate access to the client computer desktop in response to receiving a request to exit. The desktop exit component 86 enables users to eventually stop desktop access and return to normal activities within the virtual universe. Embodiments may vary, but example methods of indicating a desire to exit the desktop access session include but are not limited to a key sequence, a button or “close” icon located on the rendered top of the desktop, a “hot” region of the screen that represents an exit to the virtual universe (such that upon the movement of a pointer device into the hot region the user is returned to the virtual universe, and an action that requests the avatar to press the power button on the rendering of the computing device.

It should be obvious to those skilled in the art that no technical restriction exists to require the user only access the local computer. Other embodiments may allow users to access the desktop of remote computers from within the virtual universe 12.

In another embodiment of this invention, the desktop access tool 53 is used as a service to charge fees for access to a client computer desktop. In this embodiment, the provider of the virtual universe or a third party service provider could offer this desktop access as a service by performing the functionalities described herein on a subscription and/or fee basis. In this case, the provider of the virtual universe or the third party service provider can create, deploy, maintain, support, etc., the desktop access tool 53 that performs the processes described in the invention. In return, the virtual universe or the third party service provider can receive payment from the virtual universe residents via the universe economy management component 70 and the commercial transaction management component 72.

In still another embodiment, the methodologies disclosed herein can be used within a computer system to provide desktop access to a client computer. In this case, the desktop access tool 53 can be provided and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

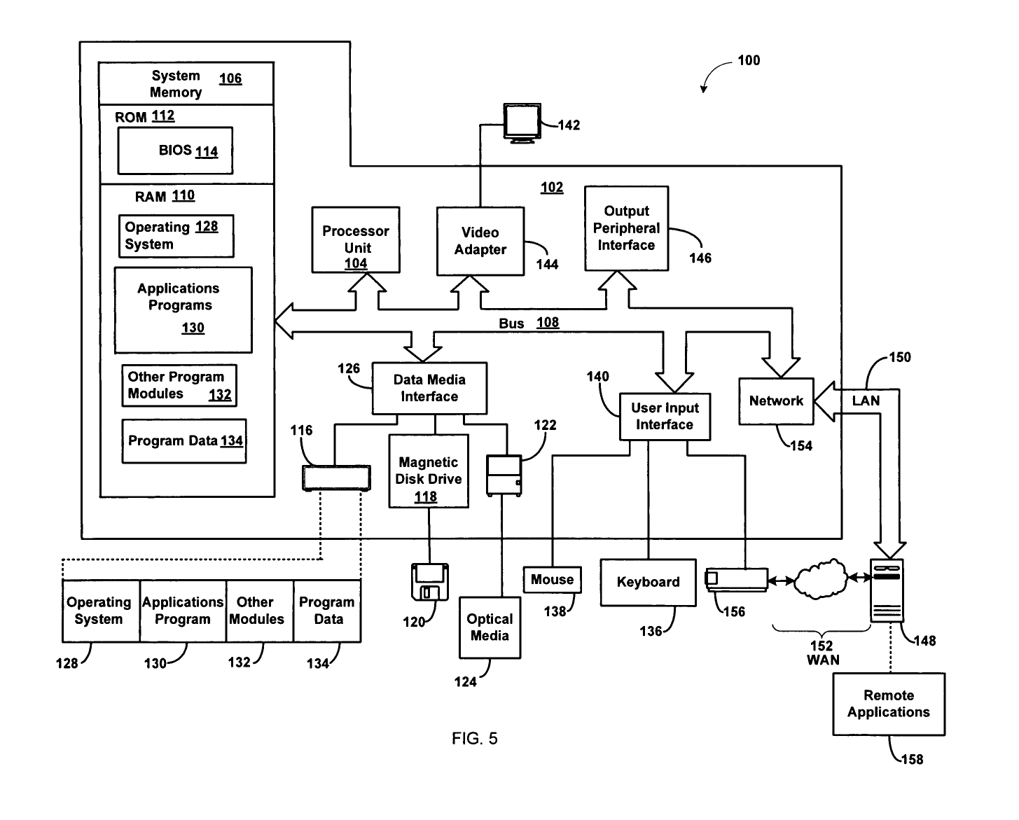

FIG. 5 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 5.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 5, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 5, the system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 5 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130 other program modules 132, and program data 134 or some combination thereof, may include an implementation of the networking environment 10 of FIG. 1 including the server array 14, the virtual universe client 24 and the desktop access tool 53. In one embodiment, the one or more application programs 130 include components of the desktop access tool 53 such as the desktop access invocation component 80, rendering component 82, interaction component 84 and desktop exit component 86.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 5 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 5 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for providing desktop access from within a virtual universe. While the invention has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for accessing a client computer desktop from within a virtual universe, comprising:
receiving a request to access the client computer desktop from within the virtual universe;
invoking the client computer desktop in response to receiving the request;
generating a rendition of the client computer desktop in the virtual universe in response to the invoking thereof; and
permitting interaction with the client computer desktop from the rendition in the virtual universe.

2. The method according to claim 1, wherein the receiving of the request to access the client computer desktop comprises receiving a selection from a user of the virtual universe.

3. The method according to claim 1, wherein the receiving of the request to access the client computer desktop comprises receiving a selection from an avatar of a user of the virtual universe.

4. The method according to claim 3, wherein the receiving of the selection from the avatar comprises the avatar approaching a rendering of the client computer desktop in the virtual universe and performing a motion indicating that the avatar desires to access the client computer desktop.

5. The method according to claim 1, wherein the rendering of the client computer desktop comprises providing a continuous display of a current state of the client computer desktop.

6. The method according to claim 1, wherein the permitting of the interaction with the client computer desktop comprises invoking application software.

7. The method according to claim 1, wherein the permitting of the interaction with the client computer desktop comprises invoking system software.

8. The method according to claim 1, wherein the permitting of the interaction with the client computer desktop comprises managing resources.

9. The method according to claim 1, wherein the permitting of the interaction with the client computer desktop comprises enabling an avatar from within the virtual universe to interact with the client computer desktop through at least one of a plurality of available actions.

10. The method according to claim 1, further comprising exiting access to the client computer desktop in response to receiving a request to terminate access thereto.

11. A computer system for permitting access to a client computer desktop from within a virtual universe, comprising:
at least one processing unit;
memory operably associated with the at least one processing unit; and
a desktop access tool storable in memory and executable by the at least one processing unit, the tool comprising:
a desktop invocation component configured to invoke the client computer desktop from within the virtual universe in response to receiving a request to access the client computer desktop from within the virtual universe;
a rendering component configured to generate a rendition of the client computer desktop in the virtual universe in response to the invoking thereof; and
an interaction component configured to permit interaction with the client computer desktop from the rendition in the virtual universe.

12. The system according to claim 11, wherein the rendering component is configured to provide a continuous display of a current state of the client computer desktop.

13. The system according to claim 11, wherein the interaction component is configured to invoke application and system software.

14. The system according to claim 11, wherein the interaction component is configured to manage resources.

15. The system according to claim 11, further comprising a desktop exit component configured to terminate access to the client computer desktop in response to receiving a request to exit.

16. A computer-readable medium storing computer instructions, which when executed, enables a computer system to access a client computer desktop from within a virtual universe, the computer instructions comprising:
invoking the client computer desktop from within the virtual universe in response to receiving a request to access the client computer desktop from within the virtual universe;
generating a rendition of the client computer desktop in the virtual universe in response to the invoking thereof; and
permitting interaction with the client computer desktop from the rendition in the virtual universe.

17. The computer-readable medium according to claim 16, wherein the rendering of the client computer desktop comprises instructions for providing a continuous display of a current state of the client computer desktop.

18. The computer-readable medium according to claim 16, wherein the permitting of the interaction with the client computer desktop comprises instructions for invoking application software and system software.

19. The computer-readable medium according to claim 16, further comprising instructions for charging a desktop access fee for permitting access to the client computer desktop from within the virtual universe.

20. A method for deploying a desktop access tool for use in a computer system that accesses a client computer desktop from within a virtual universe, comprising:
providing a computer infrastructure operable to:
receive a request to access the client computer desktop from within the virtual universe;
invoke the client computer desktop in response to receiving the request;
generate a rendition of the client computer desktop in the virtual universe in response to the invoking thereof; and
permit interaction with the client computer desktop from the rendition in the virtual universe.
